(19) United States
(12) Patent Application Publication
(10) Pub. No.: US 2009/0032716 A1
(43) Pub. Date: Feb. 5, 2009

(54) NUCLEAR MEDICINE IMAGING SYSTEM WITH HIGH EFFICIENCY TRANSMISSION MEASUREMENT

(75) Inventors: Herfried Wieczorek, Aachen (DE); Michael J. Petrillo, Pleasanton, CA (US); Carsten Degenhardt, Aachen (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 12/282,911

(22) PCT Filed: Mar. 5, 2007
(86) PCT No.: PCT/US07/63271

§ 371 Date: Sep. 15, 2008

Related U.S. Application Data
(60) Provisional application No. 60/767,263, filed on Mar. 14, 2006.

(51) Int. Cl. G01T 1/166

(52) U.S. Cl. 250/363.04

(57) ABSTRACT

A nuclear medicine imaging system that includes a plurality of detectors arranged about an imaging region. A transmission source can be provided opposite the detectors and rotating about the imaging region to obtain different imaging angles. The nuclear imaging system provides for the ability to acquire high sensitivity transmission data with high emission data spatial resolution.

The present application relates to nuclear medicine imaging systems and methods. It finds particular application in conjunction with the Single Photon Emission Tomography (SPECT) systems, and specifically cardiac SPECT systems and will be described with particular reference thereto.

Nuclear medicine imaging employs a source of radioactivity to image a patient. Typically, a radiopharmaceutical is injected into the patient. Radiopharmaceutical compounds contain a radioisotope that undergoes gamma-ray decay at a predictable rate and characteristic energy. One or more radiation detectors are placed adjacent to the patient to monitor and record emitted radiation. The radiation detector is typically a large flat scintillation crystal, such as sodium iodide, having the property of emitting light when struck by gamma photons. Affixed to the rear of this crystal are photomultiplier tubes with associated circuitry to detect the light flashes and to locate their position within the scintillation crystal. Such detector provides a two-dimensional image of radiotracer distribution. To obtain a three-dimensional image, the detector is rotated or indexed around the patient to monitor the emitted radiation from a plurality of directions. Based on information such as detected position and energy, the radiopharmaceutical distribution in the body is determined and an image of the distribution is reconstructed to study the circulatory system, radiopharmaceutical uptake in selected organs or tissue, and the like.

In standard cardiac SPECT systems, two gamma cameras rotate under an angle of 90 degrees relative to each other around the patient axis, thereby covering an overall angle of 180 degrees. This provides sufficient data to allow for reconstruction of the cardiac region. The Anger cameras used today have to be big enough to cover the full cross-section of the patient.

Transmission measurements, which allow for the generation of an attenuation map for reconstruction, are typically done using a gadolinium line source perpendicular above and at roughly 700 mm from each of the detectors. The line source is moved to cover the full detector area during each emission data acquisition frame. This enables the simultaneous measurement of transmission data on a small strip within the camera area and emission data on the remaining large part of the detector.

When transmission measurements are used only a small portion of the detector is used, thereby requiring a strong line source to enable sufficient transmission data rates. However, the strong line source can create localized high count rates, which traditional Anger cameras have difficulty handling due to their count rate limitation. In addition, the use of transmission measurements require a more complex and expensive mechanical set-up and requires additional time to allow the line source to scan across the whole camera. Furthermore, imaging of a line source can result in low-resolution attenuation data due to collimation by the camera collimator. This is especially a problem for low collimated, high efficiency cameras.

The present application provides a new and improved imaging apparatus and method which overcomes the above-referenced problems and others.

The present invention is directed to a nuclear medicine imaging system that includes a plurality of detectors arranged about an imaging region. In some embodiments the detectors are arranged in an arcuate geometry. In some embodiments a transmission source can be provided opposite the detectors and rotating about the imaging region to obtain different imaging angles. The nuclear imaging system provides for the ability to acquire high sensitivity transmission data with high emission data spatial resolution.

In the accompanying drawings, which are incorporated in and constitute a part of this specification, embodiments of the invention are illustrated, which, together with a general description of the invention given above, and the detailed description given below serve to illustrate the principles of this invention. One skilled in the art should realize that these illustrative embodiments are not meant to limit the invention, but merely provide examples incorporating the principles of the invention.

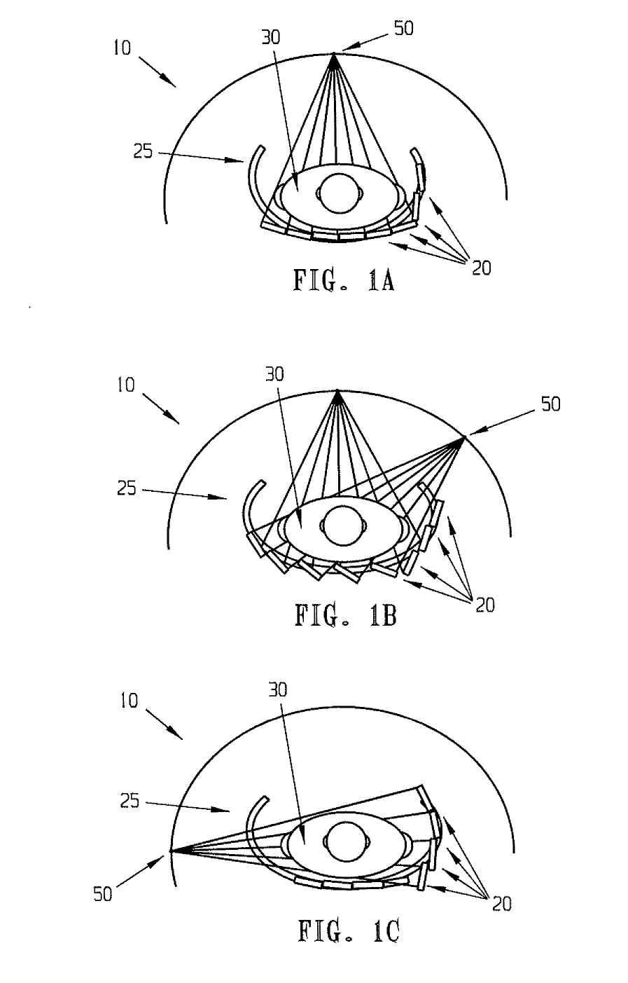

FIGS. 1a, 1b and 1c illustrate an exemplary embodiment of a SPECT system with eight detectors and a rotating transmission source.

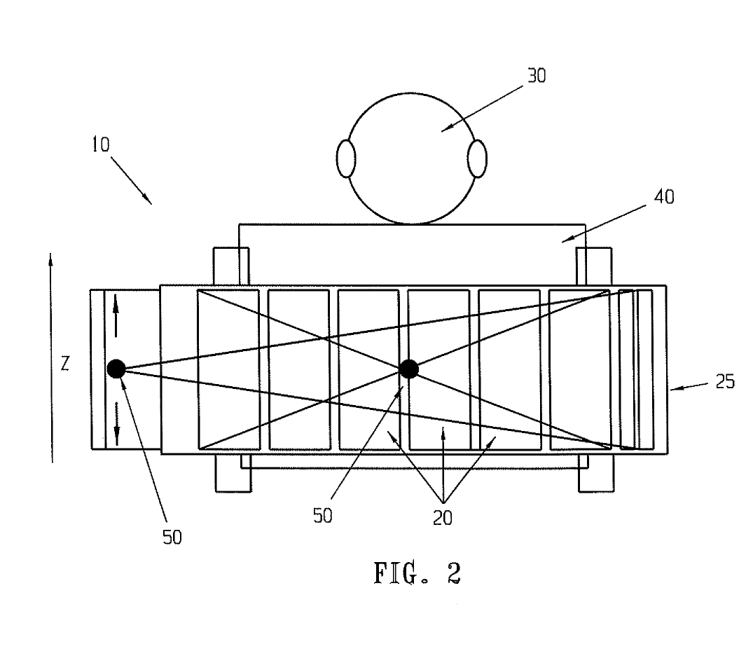

FIG. 2 illustrates a transaxial view from behind the patient showing the transmission point source in two difference positions.

A new SPECT system and imaging method incorporating a transmission source is described herein. Much higher transmission rates are achievable using the described system since a greater portion of the camera area is used for transmission measurements. The system uses a parallel collimation without truncation and enables low source activities or high transmission rates for high quality attenuation maps. As further described below, the system replaces the two traditional large rotating cameras with a large number of detectors that are either in a static position on a fixed arc-shaped gantry, the detectors rotating locally around their axes to obtain all of the data; or moving slowly on a moving arc-shaped gantry, the detectors rotating locally. It should be appreciated that while the description focuses on an arc-shaped gantry, other shapes are contemplated.

FIGS. 1a, 1b and 1c show an illustrative example of a system 10 which an arrangement of eight small detectors 20, each of them movable about the gantry, or support structure, 25 and rotatable about an axis. The detectors 20 are arranged on the gantry 25 in an arc-shaped pattern below the patient 30, resulting in a short distance between the detectors 20 and the patient, or other imaged object. It should be noted that the gantry 25 can be otherwise positioned with respect to the patient 30, such as to allow for other patient positions. For example, the detectors and gantry can be arranged to allow for imaging in the standing position or a sitting position. In addition, the gantry and detectors can be exposed directly to the patient; however for aesthetic, comfort, or technology synergistic reasons, the gantry and detectors can be enclosed or otherwise hidden from the patient's sight. For example, in some embodiments the gantry and detectors are built into a wall or wall-like structure, while in other embodiments the gantry and detectors are built into a patient table. In the embodiment that incorporates the gantry and detectors into the patient table 40, see FIG. 2, the table provides support for the patient and also hides the motion of the detectors. Other such embodiments are also contemplated by this application.

The detectors are preferably cadmium-zinc-telluride (CZT) detectors, which enable high data readout rates and high efficiency transmission measurement possibilities. Other types of detectors can also be used in this system, including, but not limited to, other solid state detectors, traditional NaI-based detectors, or detectors incorporating other scintillator materials and photodetectors. The embodiment shown in FIGS. 1a-c and 2 includes eight detectors that are about 24 cm in the axial (z) direction and 8 cm in the transaxial direction. The size of the detectors can vary in both the axial and transaxial directions. An embodiment with detectors having an axial length of about 24 cm provides adequate coverage of the cardiac region of the body. The combined width of the detectors in the transaxial direction is between 30 and 70 cm, however the overall desired width can vary depending on application. Furthermore, the number of detectors can vary between three and about twenty, although even more detectors can be used if so desired. Generally there is a tradeoff, more detectors increase the cost and complexity of the system, while fewer detectors provide for less proximity to the imaged object, or patient, thereby reducing image quality.

A transmission source 50 is provided to scan the patient and provide attenuation data, and possibly localization data, for the emission data. The transmission source 50 can be any number of sources, such as, for example, a low dose x-ray source, a gadolinium line source, a fan-beam point source, or an arrangement of point or line sources. As shown in FIGS. 1a-1c, the transmission source 50 sweeps in an accurate motion around the patient 30 to provide transmission data from different transmission angles. For example, FIG. 1a illustrates the point source directly above the patient 30. In this position, the transmission source generates transmission data across the entire transaxial width of the patient. So positioned, six of the detectors acquire transmission data simultaneously with emission data, while the remaining two detectors acquire only emission data. As the transmission source 50 is move around the patient 30, different detector combinations are used to acquire the transmission data along with the emission data, while the remaining detectors acquire only emission data. As shown in FIG. 1b, the transmission source 50 is rotated clockwise from the original position (shown) to create an angled view of the patient. So positioned, five detectors acquire transmission data along with the emission data and three detectors acquire only emission data. As shown in FIG. 1c, the transmission source 50 is rotated counterclockwise from the original position (not shown) to create a side view of the patient. So positioned, four detectors acquire transmission data and emission data simultaneously and five detectors acquire emission data. It should be noted that any number or portions of detectors may be dedicated to acquiring solely transmission data for any given amount of time or orientation.

In order to accommodate the various angled views of the patient required for three-dimensional image reconstruction, the detectors 20 rotate about an internal axis. This can be seen by comparing FIGS. 1a-1c. In addition, the detectors can translate along the arcuate path of the gantry 25 to allow for more complete and efficient coverage of the image object. For example, the detectors in FIG. 1c are translated to ensure adequate axial coverage of the patient. The system 10 can be designed such the there is efficient movement of the detectors, in rotation and translation, as to allow for complete coverage of the imaged object with the minimal amount of movement of the detectors. The detectors rotate and translate in order to follow the transmission source as it rotates about the patient and align in orientation to provide for adequate and efficient acquisition of data.

As best shown in FIG. 1a, there are no gaps between the detectors 20. Some SPECT configurations require gaps between the detectors or else one detector will cast a shadow, or block, the view another detector as the detectors pivot. This provides incomplete data. Incomplete data may be used for the emission data, however it is quite undesirable in transmission data. As best shown in FIG. 1b, even as the detectors 20 pivot, the detectors remain close together to avoid gaps in the acquisition data. Some gaps may exist, however they should be slight and negligible. Gaps may exist between the detectors acquiring the transmission data and those acquiring the emission data. This will not create incomplete data for reconstruction since the transmission source is rotated about the patient, creating different imaging angles.

It should be appreciated that the system described above will provide a modular system, with easily replaceable detector modules, that has a high sensitivity for transmission data, thereby enabling high transmission map image quality. The use of the entire detector area for transmission data acquisition further enhances the ability to obtain high quality transmission images. The detector arrangement allows for proximate imaging, thereby increasing the imaging data by 30-40 percent since the regions outside of the patient are greatly avoided. Furthermore, parallel-hole detectors can be used without truncation problems and without special reconstruction processing.

The invention has been described with reference to one or more preferred embodiments. Clearly, modifications and alterations will occur to other upon a reading and understanding of this specification. It is intended to include all such modifications, combinations, and alterations insofar as they come within the scope of the appended claims or equivalents thereof.

1. A nuclear medicine imaging system comprising,
a plurality of detectors which acquire emission data; and
an arcuate support structure, wherein said plurality of detectors are secured to the arcuate support structure thereby creating an arcuate imaging region.

2. The nuclear medicine imaging system of claim 1, wherein said arcuate support structure is a rotatable gantry that allows the detectors to translate about the imaging region.

3. The nuclear medicine imaging system of claim 1, wherein said plurality of detectors are rotatable about an axis.

4. The nuclear medicine imaging system of claim 1, wherein said plurality of detectors are positioned next to one another such as to substantially avoid gaps between detectors.

5. The nuclear medicine imaging system of claim 1 further comprising a transmission source rotatable about the imaging region.

6. The nuclear medicine imaging system of claim 5, wherein substantially the entire detector area of one or more of the plurality of detectors acquires transmission data.

7. The nuclear medicine imaging system of claim 5, wherein a first set of the plurality of detectors acquires transmission and emission data and a second set of the plurality of detectors acquires only emission data.

8. The nuclear medicine imaging system of claim 7, wherein the number of detectors in the first and second sets changes depending on a position of the transmission source.

9. The nuclear medicine imaging system of claim 8, wherein said first set of plurality of detectors are positioned next to one another such as to substantially avoid gaps between the detectors in the first set of detectors.

10. A nuclear medicine imaging system comprising,
a plurality of detectors which acquire emission data, said detectors arranged in an arcuate geometry about an imaging region; and
a transmission source rotatable about the imaging region opposite the plurality of detectors.

11. The nuclear medicine imaging system of claim 10, wherein the transmission source is used to generate an attenuation map of an imaged object.

12. The nuclear medicine imaging system of claim 10, wherein said plurality of detectors are affixed to a rotatable gantry.

13. The nuclear medicine imaging system of claim 10, wherein said plurality of detectors are rotatable about an axis.

14. The nuclear medicine imaging system of claim 10 comprising between four and twenty detectors.

15. The nuclear medicine imaging system of claim 10, wherein substantially the entire detector area of one or more of the plurality of detectors acquires transmission data.

16. The nuclear medicine imaging system of claim 10, wherein a first set of the plurality of detectors acquires transmission and emission data and a second set of the plurality of detectors acquires only emission data.

17. The nuclear medicine imaging system of claim 16, wherein the number of detectors in the first and second sets changes depending on a position of the transmission source.

18. The nuclear medicine imaging system of claim 16, wherein said first set of plurality of detectors are positioned next to one another such as to substantially avoid gaps between the detectors in the first set of detectors.

19. The nuclear medicine imaging system of claim 10 wherein the plurality of detectors are housed within a patient table or wall-like structure.

20. A nuclear medicine imaging system comprising,
a plurality of detectors arranged about an imaging region; and
a transmission source rotatable about the imaging region opposite the plurality of detectors;
wherein a first set of detectors simultaneously acquire transmission and emission data and a second set of detectors acquire only emission data, wherein the number of detectors in said first and second sets chances depending on the position of the transmission source.

21. The nuclear medicine imaging system of claim 20, wherein the plurality of detectors are arranged in an arcuate geometry about the imaging region.

22. The nuclear medicine imaging system of claim 20, wherein the plurality of detectors are rotatable about an internal axis and are translatable about the imaging region.

23. A method of imaging an object comprising,
arranging a plurality of detectors about an imaging region in an arcuate geometry;
rotating a transmission source about the imaging region opposite the plurality of detectors;
using the detectors to acquire both transmission and emission data; and
reconstructing an image based on the acquired data.

24. The method of claim 23 further comprising,
translating the plurality of detectors about the imaging region; and
rotating the plurality of detectors about an internal axis.
